(19) United States
(12) Patent Application Publication
(10) Pub. No.: US 2008/0099562 A1
(43) Pub. Date: May 1, 2008

(54) PACKING ENVELOPE PRINTING METHOD FOR AUTOMATIC MEDICINE PACKING MACHINE

(76) Inventor: Jun Ho Kim, Taegu (KR)

Correspondence Address: PARK LAW FIRM, 3255 WILSHIRE BLVD, SUITE 1110, LOS ANGELES, CA, 90010, US

(21) Appl. No.: 11/624,602

(22) Filed: Jan. 18, 2007

(30) Foreign Application Priority Data
Nov. 1, 2006 (KR) 10-2006-0107413

(51) Int. Cl. G06K 7/10

(52) U.S. Cl. 235/462.01

(57) ABSTRACT

A packing envelope printing method for an automatic medicine packing machine includes steps of calculating data amount, deciding excess data, in which whether the calculated data amount exceeds a reference data amount that is preset is decided; selecting bar code printing method according to the decision, in which one dimension bar code or two dimension bar code is selected and data printing, in which a bar code and predetermined print data are printed on the front surface of the packing envelope with the selected bar code printing method. The method also includes steps of deciding bar code size and position, designating additional print data, previewing, correcting printing error, and printing a header packet and a footer packet.

### CLAIMING FOREIGN PRIORITY

The applicant claims and requests a foreign priority, through the Paris Convention for the Protection of Industrial Property, based on patent applications filed in the Republic of Korea (South Korea) with the filing date of Nov. 1, 2006 with the patent application number 10-2006-0107413 by the applicant, the contents of which are incorporated by reference into this disclosure as if fully set forth herein.

### BACKGROUND OF THE INVENTION

The present invention relates to an automatic medicine packing machine that automatically packs medicine per dose. More particularly, the present invention relates to a method of printing label that enables easy printing of various and large information and prevents insufficient expression of information.

Generally, an automatic medicine packing machine continuously packs medicine that is dispensed per dose. Construction and operation of an automatic medicine packing machine are explained referring to FIG. 5. The automatic medicine packing machine includes a plurality of tablet cassettes 100 that are received on a shelf in the upper part of the machine, a tablet dispenser 200, a hopper 300 that is provided below the tablet cassettes 100 and the tablet dispenser 200, a printing unit 400, and a sealing unit 500 that moves and seals packing envelopes on which labels are printed by the printing unit 400.

The operation of the printing unit 400 is controlled by a controller C that is provided inside the machine. The controller C controls the printing unit 400 to print label on the outer surface of the packing envelope according to printing information provided by a server S that is provided outside the machine.

FIG. 6 shows that a packing envelope P, on which information was printed by the printing unit 400, is folded into two layers with a triangular plate T, and fed downward by a feed roller 501, and sealed with a width sealing roller 502 and a length sealing roller 503 forming a bundle 540 of packed medicine 510. FIG. 7 shows thus formed bundle of packed medicine, and one dimension bar code labels 504 printed on the front surfaces of the envelopes of the bundle. A user can retrieve data for the packed medicine by scanning the one dimension bar code with a bar code reader.

Disadvantages of the prior art are that one dimension bar code has a limit in the amount of information that it can contain and data was insufficiently represented as a result; erroneous and defective printing of the bar code frequently occurred; and the start and end of the bundle for a patient was not easily recognized making it difficult to handle and manage the bundles per patient.

### SUMMARY OF THE INVENTION

The present invention contrives to solve the disadvantages of the prior art.

An objective of the invention is to provide a printing method that supplements functions of one dimension bar code, prevents limited representation of information by one dimension bar code, and enables printing of large and various information.

Another objective of the invention is to provide a printing method in which arrangement of bar code position and size is conveniently controlled by user's intention thereby preventing error or defect in printing position.

Still another objective of the invention is that the method enables checking of the printing position and the size of the letter chosen with naked eye, thereby facilitating checking and prevention of defective printing.

Still another objective of the invention is to facilitate distinction of packed medicine bundles per patient, and recognition of information and notices for medicine for a particular patient.

In order to achieve the above objective, the present invention provides a packing envelope printing method for an automatic medicine packing machine that includes steps of calculating data amount, in which amount of data that is to be printed on a front surface of a packing envelope is calculated for each patient, and the packing envelope contains medicine for one dose; deciding excess data, in which whether the calculated data amount exceeds a reference data amount that is preset is decided; selecting bar code printing method according to the decision, in which if the calculated data amount is less than or equal to the reference data amount, one dimension bar code printing is selected, and if the calculated data amount is greater than the reference data, two dimension bar code printing is selected; and data printing, in which a bar code and predetermined print data are printed on the front surface of the packing envelope with the selected bar code printing method. In the step of calculating data amount, the data amount is calculated by counting the number of letters that are to be printed. In the step of deciding excess data, the reference data amount is a maximum amount that can be printed with a one dimension bar code.

The method further includes a step of deciding bar code size and position after the step of selecting bar code printing method, in which size and printing position of a bar code are selected for a given size of the packing envelope for one dose.

The method further includes a step of designating additional print data after the step of deciding bar code size and position, in which data to be printed on the front surface of the packing envelope in addition to the bar code is designated, and then size of letter and printing position for the additional print data are decided. The additional print data includes a patient name, a patient number, a hospital name, a medicine name, and a medicine administering date.

The method further includes a step of previewing after the step of designating additional print data, in which the bar code and additional print data for each patient are displayed on an imaginary packing envelope for visual check by a user's naked eye.

The method further includes a step of print error solving after the step of previewing, in which when there is an error or defect in the displayed bar code and/or the additional print data, the error or defect is solved by adjusting the size and position of the bar code and/or the additional print data so that no error occurs in actual printing.

The method further includes a step of printing a header packet before the step of calculating data amount, in which predetermined data are printed on a header packet which is located at the preceding end of packing envelope bundle for a particular patient. The predetermined data include patient information, number of packing envelopes and data for packed medicine.

The method further includes a step of printing warning message after the step of printing header packet, in which whether there is a warning message for the medicine that is printed on the header packet is searched, and if a warning message is found, the warning message is printed on the header packet.

The method further includes a step of printing a footer packet after the step of data printing, in which after completion of printing on the front surfaces of the packing envelopes, predetermined data for each patient are printed on a footer packet that is attached on the end of the packing envelope bundle. The predetermined data include patient information, number of packing envelopes and data for packed medicine.

The advantages of the present invention are: (1) the function of one dimension bar code is supplemented, limit of one dimension bar code is overcome, and printing various and rich information on a packing envelope is facilitated; (2) the user can easily select the size and position of a bar code, prevention of error or defect in printing is facilitated, and printing on packing envelopes is performed more precisely; (3) visual checking of printing position and letter size facilitates preventing printing error, improving printing accuracy and correction of printing error; and (4) distinction, handling and maintenance of packing envelope bundle for each patient are facilitated, and recognition of data and cautions for medicine by a patient is facilitated.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a flow diagram showing a method of printing according to the present invention;

FIG. 2 is a plan view showing labels printed by the method of the present invention;

FIG. 3 is a plan view showing a preview label;

FIG. 4 is a plan view showing a header packet;

FIG. 5 is an elevation view showing an automatic medicine packing machine by prior art;

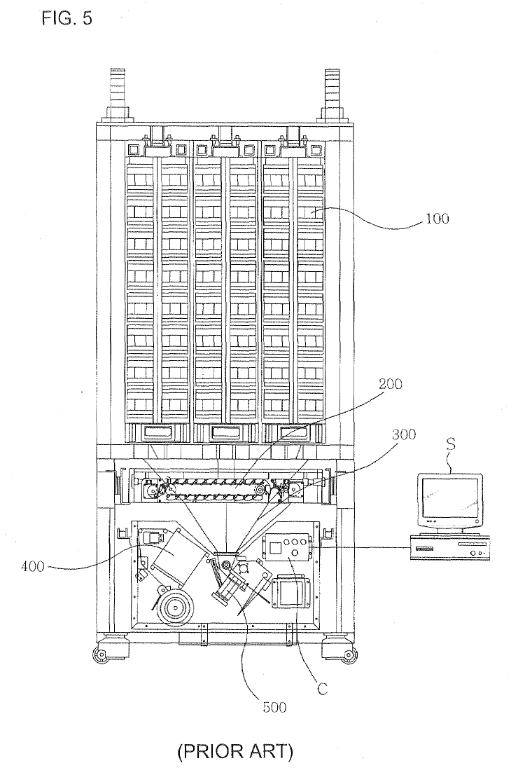

FIG. 6 is an enlarged partial sectional view showing an printing unit's operation; and

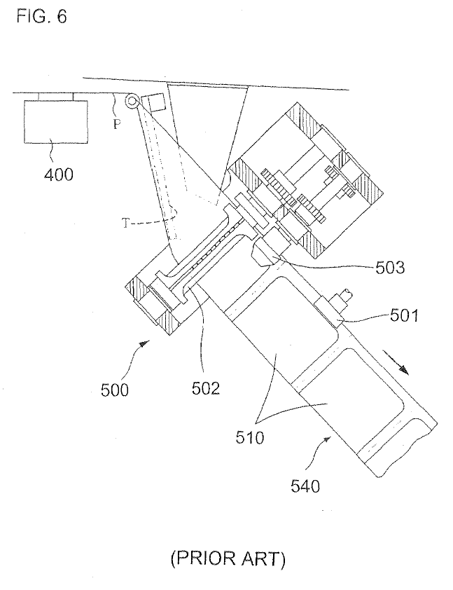

FIG. 7 is a plan view showing printed labels by prior art.

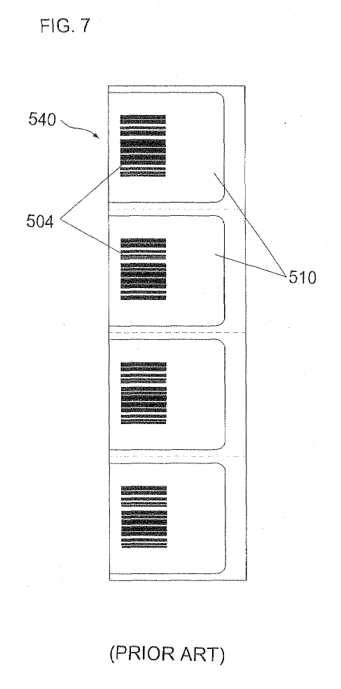

### DETAILED DESCRIPTION OF THE INVENTION

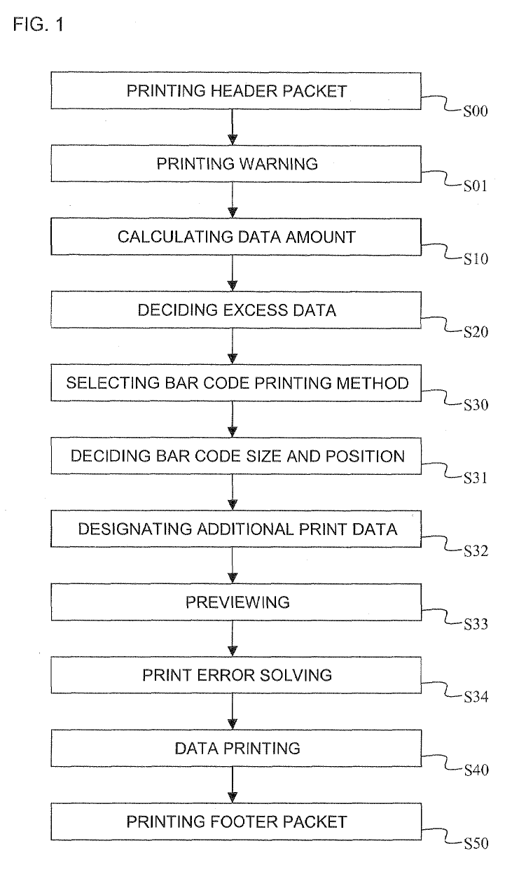

FIG. 1 shows a method of printing label for an automatic medicine packing machine. The method includes step S10 of calculating data amount, in which amount of data that is to be printed on a front surface of a packing envelope is calculated, step S20 of deciding excess data, in which whether the calculated data amount exceeds a reference data amount that is preset is decided, step S30 of selecting bar code printing method according to the decision, and step S40 of data printing, in which a bar code and predetermined print data are printed on the front surface of the packing envelope with the selected bar code printing method.

In step S10, the amount of data is calculated per patient. Generally, the amount is calculated by counting the number of letters that are to be printed.

In step S20, the reference data amount is an amount that can be printed with a one dimension bar code.

In step S30, if the calculated data amount is less than or equal to the reference data amount, one dimension bar code printing is selected, and if the calculated data amount is greater than the reference data amount, two dimension bar code printing is selected. In this way, the limit of data for one dimension bar code is easily overcome and printing various and rich information is possible.

The method further includes step S31 of deciding bar code size and position after step S30. In step S31, the size and printing position of a bar code are selected for a given size of the packing envelope for one dose. This step facilitates preventing of printing position error and defect, especially for a two dimension bar code that has more complex shape by selecting the position and size of the bar code in advance.

The method further includes step S32 of designating additional print data after step S31. In step S32, data to be printed on the front surface of the packing envelope in addition to the bar code is designated, and then size of letter and printing position for the additional print data are decided. The user designates the additional print data, which includes patient name, patient number, hospital name, medicine name, medicine administering date and treating section etc.

The method further includes step S33 of previewing after step S32. In step S33, the bar code and additional print data for a particular patient are displayed on an imaginary packing envelope with a display, for example a monitor of a server for visual check by the user's naked eye.

The method further includes step S34 of print error solving after step S33. In step S34, when there is an error or defect in the displayed bar code and/or the additional print data, the error or defect is solved by adjusting the size and position of the bar code and/or the additional print data so that no error occurs in actual printing.

The method further includes step S00 of printing header packet before step S10. In step S00, patient information, number of packing envelopes and data for packed medicine are printed on a header packet which is located at the preceding end of packing envelope bundle for a particular patient. In this way, distinction, handling and management of packing envelope bundle per patient are facilitated.

The method further includes step S01 of printing warning message after step S00. In step S01, whether there is a warning message for the medicine that is printed on the header packet is searched, and if a warning message is found, the warning message is printed on the header packet thereby facilitating recognition of cautions and other information for the medicine.

The method further includes step S50 of printing a footer packet after step S40. In step S50, after completion of printing on the front surfaces of the packing envelopes, data for each patient, medicine and number of packing envelopes is printed on a footer packet that is attached on the end of the packing envelope bundle. In this way, like the case for the header packet, distinction, handling and management of packing envelope bundle per patient are facilitated.

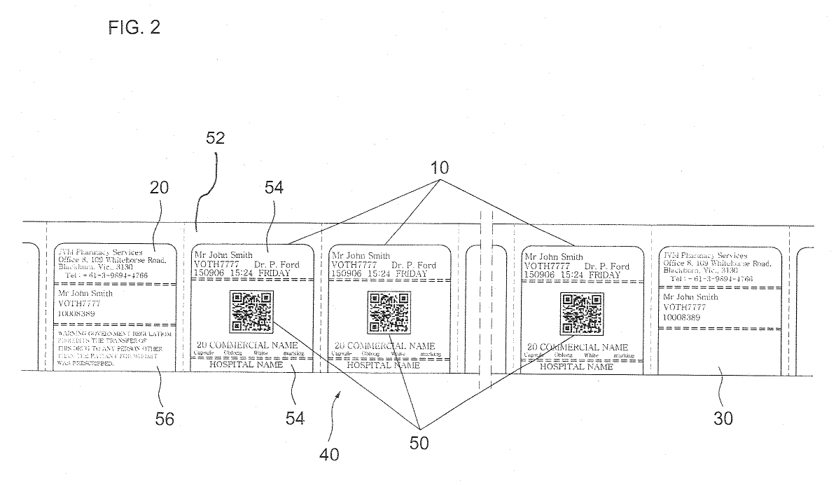

FIG. 2 shows data printed on the packing envelope bundle 40 for a patient. The bundle includes a plurality of packing envelopes 10, each of which includes one dose of medicine for the patient, a header packet 20 and a footer packet 30. The header packet and footer packet are vacant packing envelopes.

A two dimension bar code 50 is printed on the front surface 52 of the packing envelope 10. Additional print data 54, which includes patient name, hospital name and patient number, are printed above and below the two dimension bar code 50. Data for patient and packed medicine are printed on the header packet 20 and the footer packet 30. A warning message 56 is printed on the lower part of the header packet 20.

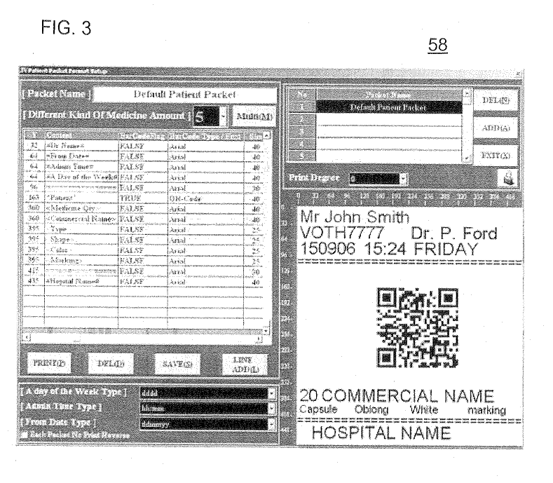

FIG. 3 shows a preview 58 displayed on a monitor. The user can visually verify whether designation of size and position of the bar code and additional print data is correct, and can easily correct if there is an error.

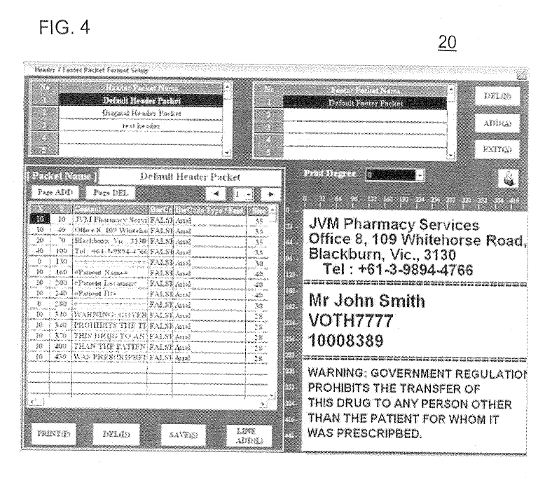

FIG. 4 shows print data for the header packet. As shown, the print data is directly set by the user with the monitor screen. The print data is also applied to the footer packet. The size and position of the print data for the header packet and the footer packet are also adjustable when the user sets the print data.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A packing envelope printing method for an automatic medicine packing machine comprising steps of:
a) calculating data amount, wherein amount of data that is to be printed on a front surface of a packing envelope is calculated for each patient, wherein the packing envelope contains medicine for one dose;
b) deciding excess data, wherein whether the calculated data amount exceeds a reference data amount that is preset is decided;
c) selecting bar code printing method according to the decision, wherein if the calculated data amount is less than or equal to the reference data amount, one dimension bar code printing is selected, and if the calculated data amount is greater than the reference data amount, two dimension bar code printing is selected; and
d) data printing, wherein a bar code and predetermined print data are printed on the front surface of the packing envelope with the selected bar code printing method.

2. The method of claim 1, further comprising a step of deciding bar code size and position after the step of selecting bar code printing method, wherein size and printing position of a bar code are selected for a given size of the packing envelope for one dose.

3. The method of claim 2, further comprising a step of designating additional print data after the step of deciding bar code size and position, wherein data to be printed on the front surface of the packing envelope in addition to the bar code is designated, and then size of letter and printing position for the additional print data are decided.

4. The method of claim 3, wherein the additional print data includes a patient name, a patient number, a hospital name, a medicine name, and a medicine administering date.

5. The method of claim 3, further comprising a step of previewing after the step of designating additional print data, wherein the bar code and additional print data for each patient are displayed on an imaginary packing envelope for visual check by a user's naked eye.

6. The method of claim 5, further comprising a step of print error solving after the step of previewing, wherein when there is an error or defect in the displayed bar code and/or the additional print data, the error or defect is solved by adjusting the size and position of the bar code and/or the additional print data so that no error occurs in actual printing.

7. The method of claim 1, further comprising a step of printing a header packet before the step of calculating data amount, wherein predetermined data are printed on a header packet which is located at the preceding end of packing envelope bundle for a particular patient.

8. The method of claim 7, wherein the predetermined data include patient information, number of packing envelopes and data for packed medicine.

9. The method of claim 7, further comprising a step of printing warning message after the step of printing header packet, wherein whether there is a warning message for the medicine that is printed on the header packet is searched, and if a warning message is found, the warning message is printed on the header packet.

10. The method of claim 7, further comprising a step of printing a footer packet after the step of data printing, wherein after completion of printing on the front surfaces of the packing envelopes, predetermined data for each patient are printed on a footer packet that is attached on the end of the packing envelope bundle.

11. The method of claim 10, the predetermined data include patient information, number of packing envelopes and data for packed medicine.

12. The method of claim 1, wherein in the step of calculating data amount, the data amount is calculated by counting the number of letters that are to be printed.

13. The method of claim 1, wherein in the step of deciding excess data, the reference data amount is a maximum amount that can be printed with a one dimension bar code.

14. The method of claim 1, further comprising a step of previewing after the step of selecting bar code printing method, wherein the bar code and additional print data for each patient are displayed on an imaginary packing envelope for visual check by a user's naked eye.

15. The method of claim 14, further comprising a step of print error solving after the step of previewing, wherein when there is an error or defect in the displayed bar code, the error or defect is solved by adjusting the size and position of the bar code so that no error occurs in actual printing.

16. The method of claim 1, further comprising a step of printing a footer packet after the step of data printing, wherein after completion of printing on the front surfaces of the packing envelopes, predetermined data for each patient are printed on a footer packet that is attached on the end of the packing envelope bundle.
